(19) United States
(12) Patent Application Publication
(10) Pub. No.: US 2010/0248790 A1
(43) Pub. Date: Sep. 30, 2010

(54) PORTABLE ELECTRONIC APPARATUS

(75) Inventors: Imamura Motonori, Kanagawa (JP); Wataru Takahashi, Kanagawa (JP); Kousuke Takahashi, Kanagawa (JP); Takashi Hasegawa, Kanagawa (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/740,308

(22) PCT Filed: Oct. 30, 2008
(86) PCT No.: PCT/JP2008/069811

§ 371 Date: Jun. 17, 2010

(30) Foreign Application Priority Data
Oct. 30, 2007 (JP) 2007-281515
Oct. 30, 2007 (JP) 2007-281516

(51) Int. Cl. H04M 1/02

(52) U.S. Cl. 455/566; 455/575.3

(57) ABSTRACT

A portable electronic apparatus which can be made compact and thin in the set thickness direction of the case while securing sufficient strength of the case. The portable telephone (1) has a substantially planar first case (3), and an underside case (2) connected to the first case (3) through a hinge portion (4). The hinge portion (4) has a fixed portion (21) being fixed in the first case (3) equipped with a sheet metal member (33) having a folded portion (34) where the end portion is folded in the thickness direction of the first case (3). The folded portion (34) of the sheet metal member (33) has screw holes (34a) and tightened to the fixed portion (21) concurrently by means of screws (28) inserted into the screw holes (34a) in the direction intersecting the thickness direction of the first case (3) perpendicularly.

### TECHNICAL FIELD

The present invention relates to a portable electronic apparatus such as a cellular telephone.

### BACKGROUND ART

Conventionally, in a cellular telephone as a portable electronic apparatus, a biaxial hinge mechanism is used as a hinge portion in order to connect a plurality of bodies composed of a second body and a first body to be openable/closable and rotatable. The biaxial hinge mechanism includes a first axial hinge for opening and closing and a second axial hinge for rotating, in which the second body is fixed to the first axial hinge and the first body is fixed to the second axial hinge. Such a conventional structure is disclosed in the following Patent Documents.

Patent Documents 1 to 3 disclose a threaded fixing mechanism in a direction orthogonal to a rotational axis of the second axial hinge. Patent Document 4 discloses a threaded fixing mechanism in a direction parallel to the rotational axis of the second axial hinge.

In addition, conventionally, a cellular telephone and the like having a body formed mainly of resin are becoming smaller in thickness, and therefore it is required to maintain the strength of the body. Given this, in order to maintain the strength of the body, a metal frame formed of a metal plate or by die casting is disposed in the body formed of resin. Patent Documents 5 and 6 disclose disposing a structure obtained by resin insert molding of a metal plate and a metal frame inside a body formed of resin, for a further reduction in thickness of the body.

Patent Document 1: Japanese Unexamined Patent Application, Publication No. 2004-218688

Patent Document 2: Japanese Unexamined Patent Application, Publication No. 2005-311004

Patent Document 3: Japanese Unexamined Patent Application, Publication No. 2006-10025

Patent Document 4: Japanese Unexamined Patent Application, Publication No. 2003-174495

Patent Publication 5: Japanese Unexamined Patent Application, Publication No. 2004-228238

Patent Publication 6: Japanese Unexamined Patent Application, Publication No. 2007-53450

### DISCLOSURE OF THE INVENTION

### Problems to be Solved by the Invention

However, in the technique disclosed in Patent Documents 1 to 4, one of the axial hinges (the second axial hinge) in the biaxial hinge mechanism that connects two bodies is fixed by threads in a thickness direction of a set of the second body and the first body (in an overlapping direction of the bodies). Therefore, a thickness in the thickness direction of the set of the bodies increases, thereby preventing a reduction in thickness of the electronic apparatus.

In addition, the biaxial hinge mechanism is formed by modularizing by way of die-casting with magnesium or the like; however, there is a limitation in reducing the thickness of the body from a viewpoint of securing the strength of the biaxial hinge mechanism. Therefore, there is a problem in that a restriction is imposed on reductions in thickness and size of the electronic apparatus. The same applies to a hinge mechanism other than the biaxial hinge mechanism (for example, a uniaxial hinge mechanism).

In addition, in such a portable electronic apparatus, as disclosed in Patent Documents 5 and 6, the metal frame for securing the strength of the body needs to be fixed by threads to other component inside the body. Firmer and more reliable threaded fixing is required for fixing the metal frame.

The present invention is made in view of the abovementioned problems and aims at providing a portable electronic apparatus that allows for a reduction in thickness in a thickness direction and a size of a set of the bodies, while securing sufficient strength of the bodies.

### Means for Solving the Problems

The present invention relates to a portable electronic apparatus including: a first body that is substantially flat plate shaped; a second body; and a hinge portion that has a fixing portion that is fixed inside the first body and that connects the first body with the second body, in which the first body includes a metal plate member having a bent portion on an end side thereof that is bent in a thickness direction of the first body, and in which the bent portion of the metal plate member has a threaded hole and is tighten together with the fixing portion by way of a screw that is inserted into the threaded hole in a direction orthogonal to a thickness direction of the first body.

In addition, it is preferable that the hinge portion includes a first rotational axis that allows the first body to transition between an opened state and a closed state with respect to the second body, and a second rotational axis that allows the first body to rotate with respect to the second body by way of an axis orthogonal to the first rotational axis; the hinge portion is fixed to the second body so as to be rotatable about the first rotational axis; and the fixing portion is rotatable about the second rotational axis with respect to the hinge portion.

In addition, it is preferable that the first body is configured to include a body piece obtained by resin insert molding of the metal plate member, and the bent portion of the metal plate member is tightened together with the fixing portion by way of the screw via a resin layer formed by the resin insert molding.

In addition, it is preferable that the first body includes a display, and the metal plate member is a member that holds a back face side of the display.

In addition, it is preferable that the first body includes a sub-display; the metal plate member is provided with a standing tooth portion that is formed by cutting out and bending a portion of the metal plate member toward the back face side of the display; and the sub-display is positioned by the standing tooth portion.

In addition, it is preferable that the resin layer formed on the bent portion includes a screw stopping surface on a first face thereof that a head of the screw abuts; and a sloped surface having a predetermined slope with respect to the screw stopping surface and a projecting surface that has a face parallel to the screw stopping surface and projects more than the slope surface are formed on a face thereof that is opposite to the first face.

In addition, it is preferable that an area of the sloped surface is greater than that of the projecting surface.

In addition, it is preferable that a surface direction of the screw stopping surface and the projecting surface is parallel to a die removal direction in molding of the first body piece, and the projecting surface is continuously formed in a direction corresponding to the die removal direction.

In addition, the present invention relates to a portable electronic apparatus including a first body configured to include a first body piece obtained by resin insert molding of a metal member, in which: the metal member includes a fastening portion provided with a threaded hole; the first body piece is configured by resin insert molding so that a resin layer is formed in the fastening portion of the metal member; and the fastening portion of the first body piece is fixed by threads to another component with the resin layer interposed therebetween, by way of a screw inserted into the threaded hole.

In addition, it is preferable that the resin layer includes a screw stopping surface on a first face thereof that a head of the screw abuts; and a sloped surface having a predetermined slope with respect to the screw stopping surface and a projecting surface that has a face parallel to the screw stopping surface and projects more than the sloped surface are formed that is opposite to the first face on a face.

In addition, it is preferable that an area of the sloped surface is greater than that of the projecting surface.

In addition, it is preferable that a surface direction of the screw stopping surface and the projecting surface is parallel to a die removal direction in molding of the first body piece, and the projecting surface is continuously formed in a direction corresponding to the die removal direction.

In addition, it is preferable that the metal member includes a metal plate member and the fastening portion is formed by processing to bend.

In addition, it is preferable that a second body that is connected to the first body via a hinge member so as to be openable and closable is further included, in which the other component is a component of the hinge member.

In addition, it is preferable that the hinge member includes a second rotational axis with a direction vertical to the fastening portion set as an axis, and the fastening portion is provided at two positions interposing the second rotational axis.

In addition, it is preferable that the first body includes a display that is exposed on at least one face of the first body; the hinge member includes a first rotational axis with a direction orthogonal to the second rotational axis set as an axis; and the first body is foldable with respect to the second body, with the display facing inside, by way of the first rotational axis.

In addition, it is preferable that the first body includes a first display and a second display so as to be exposed on faces thereof, and the metal plate member is disposed between the first display and the second display and holds back faces of the first display and the second display, respectively.

In addition, it is preferable that the first display is greater in size than the second display; the metal plate member includes a standing tooth portion, which is formed by bending, on a face opposite to a face holding the first display; and the second display is held by the standing tooth portion.

### EFFECTS OF THE INVENTION

The present invention can provide a portable electronic apparatus that allows for a reduction in thickness in a thickness direction and a size of a set of the bodies, while securing sufficient strength of the bodies.

### BRIEF DESCRIPTION OF THE DRAWINGS

FIG. 1 is a perspective view of showing an opened state of a cellular telephone as a first embodiment of a portable electronic apparatus according to the present invention;

FIG. 2 is a perspective view showing the cellular telephone shown in FIG. 1 in a state in which a display unit side body is being pivoted;

FIG. 3 is a perspective view showing the cellular telephone shown in FIG. 1 in a state in which the display unit side body has been pivoted;

FIG. 4 is a perspective view showing a closed state of the cellular telephone shown in FIG. 1;

FIG. 5 is a front view showing a closed state of the cellular telephone shown in FIG. 1;

FIG. 6 is an exploded perspective view showing an installation structure of a biaxial hinge mechanism of the cellular telephone shown in FIG. 1;

FIG. 7 is a perspective view showing installation of the biaxial hinge mechanism to the display unit side body of the cellular telephone shown in FIG. 1;

FIG. 8 is a partially enlarged perspective view of FIG. 7;

FIG. 9 is a perspective view showing the cellular telephone shown in FIG. 1 in a state in which the biaxial hinge mechanism is installed on the display unit side body thereof;

FIG. 10 is a perspective view showing a connection between the biaxial hinge mechanism and an operation unit side body of the cellular telephone shown in FIG. 1;

FIG. 11 is a partially enlarged perspective view showing a connection wall portion;

FIG. 12 is a plan view showing a connection wall portion; and

FIG. 13 is an exploded perspective view showing components inside the display unit side body.

### PREFERRED MODE FOR CARRYING OUT THE INVENTION

An embodiment of the present invention is described hereinafter with reference to the drawings. It should be noted that, although a cellular telephone is described hereinafter as a mobile electronic apparatus, the present invention is not limited thereto and may be PHS (Personal Handyphone System), a PDA (Personal Digital Assistant), a portable navigation apparatus, a laptop computer, and the like.

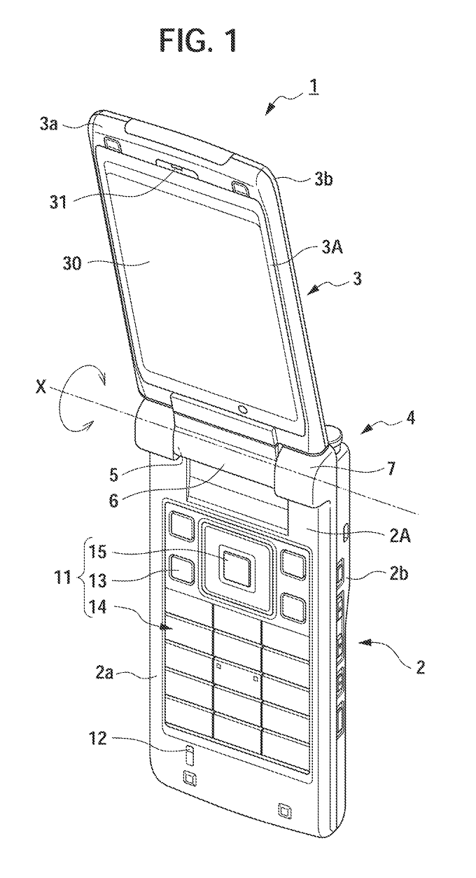

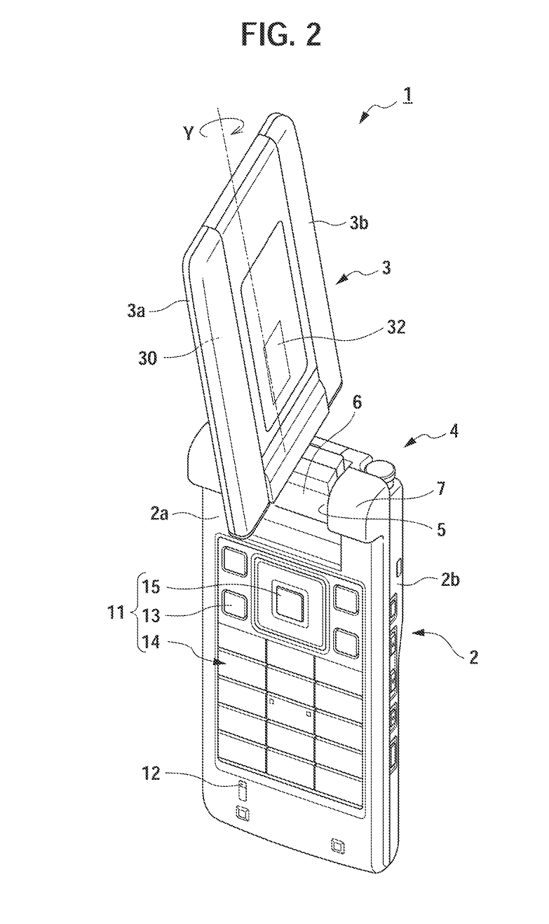

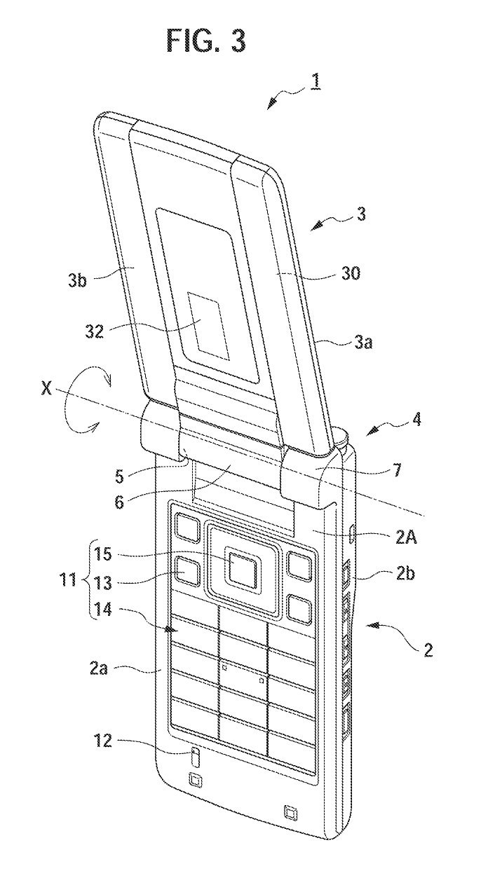

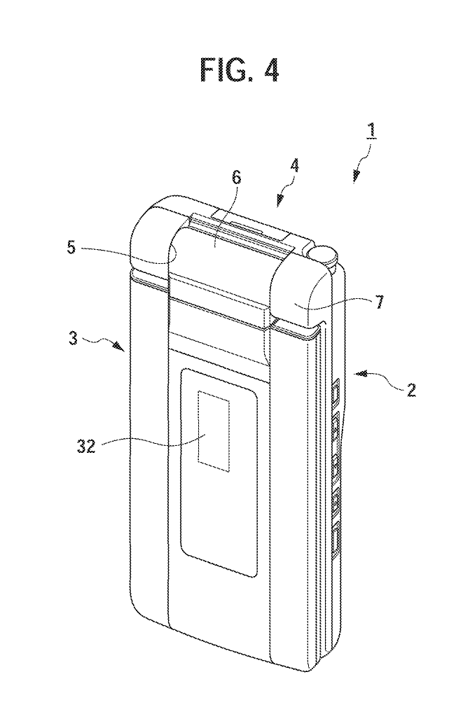

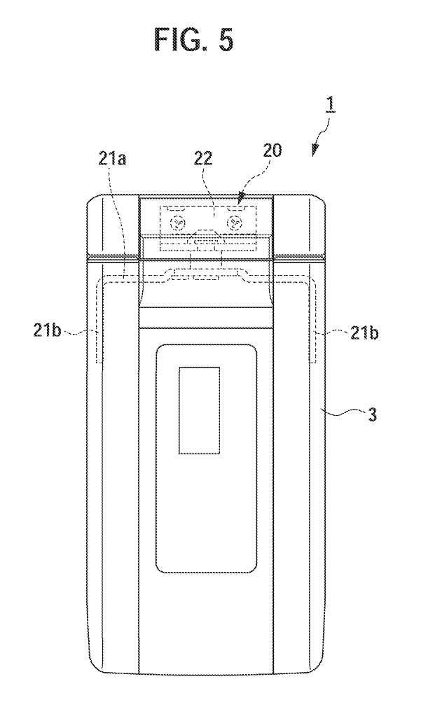

A basic configuration of a cellular telephone 1 as a portable electronic apparatus of the present invention is described with reference to the FIGS. 1 to 5. FIG. 1 is a perspective view of showing an opened state (a first opened state) of a cellular telephone 1 as a first embodiment of a portable electronic apparatus according to the present invention. FIG. 2 is a perspective view of the cellular telephone 1 in a state in which a display unit side body 3 is pivoted at a predetermined angle around a pivot axis Y of a connecting portion 4. FIG. 3 is a perspective view showing a state in which the display unit side body 3 has been pivoted in the first opened state shown in FIG. 1. FIG. 4 is a perspective view of the cellular telephone 1 in a closed state in which the display unit side body 3 is placed over an operation unit side body 2. FIG. 5 is a front view of the cellular telephone 1 in a closed state.

The cellular telephone 1 of the present embodiment includes the operation unit side body 2 as a second body and the display unit side body 3 as a first body. The operation unit side body 2 and the display unit side body 3 are connected via the connecting portion 4 provided with a biaxial hinge mechanism. The connecting portion 4 makes the cellular telephone 1 switchable between the opened state and the closed state, and allows for switching of the display unit side body 3 between a front side state and a back side state both in the opened state and the closed state.

Here, the closed state is a state in which the bodies 2 and 3 are disposed so as to overlap each other. The opened state is a state in which the bodies 2 and 3 are disposed so as not to overlap each other. Here, the front side state in the opened state refers to a state in which a display 30 disposed on a front face 3A of the display unit side body 3 (described later) and the operation key group 11 disposed on the front face 2A of the operation unit side body 2 are disposed so as to face the same side (see FIG. 1). In addition, the back side state in the opened state refers to a state in which the display 30 in the display unit side body 3 and the operation key group 11 in the operation unit side body 2 are disposed so as to face opposite sides (see FIG. 3). Moreover, the front side state in the closed state refers to a state in which the display 30 in the display unit side body 3 is disposed to oppose the operation key group 11 in the operation unit side body 2 (see FIGS. 4 and 5). The back side state in the closed state refers to a state in which the display 30 in the display unit side body 3 is exposed without opposing the operation key group 11 in the operation unit side body 2 (not shown).

The operation unit side body 2 has an outer surface composed of a front case 2a and a rear case 2b. The operation unit side body 2 is configured to expose both an operation key group 11 on the front case 2a side and a sound input unit 12 where the sound of the user of the cellular telephone apparatus 1 is input when conversing. Here, the operation key group 11 is composed of: function setting operation keys 13 for operating various functions such as for various settings, a telephone number directory function and a mail function; an input operation key 14 such as ten keys for inputting digits of a telephone number and characters for mail, and a selection operation key 15 that performs confirmation of the various operations and scrolls up, down, left and right. The sound input unit 12 is disposed on an outer end portion side that is opposite to the connecting portion 4 side in a longitudinal direction of the operation unit side body 2. In other words, the sound input unit 12 is disposed in a first outer end portion side in the longitudinal direction of the operation unit side body 2 in the opened state of the cellular telephone 1.

Selected features are assigned to each of the keys (key assignment) composing the operation key group 11 according to a deformed state of the operation unit side body 2 and the display unit side body 3, such as the opened or closed state, the front side or back side state and the like, and the type of application that is running. An operation corresponding to a feature assigned to each key is executed by a user pressing one of the keys composing the operation key group 11 of the cellular telephone 1.

The display unit side body 3 has an outer surface composed of a front case 3a and a rear case 3b, and is substantially flat plate shaped. A display 30 (a first display) of a predetermined shape for displaying a variety of information, and a sound output unit 31 that outputs sound of the other party of the conversation are disposed to be exposed on the front case 3a of the display unit side body 3. The sound output unit 31 is disposed on an outer end portion side that is opposite to the connecting portion 4 in the longitudinal direction of the display unit side body 3. In other words, the sound output unit 31 is disposed in a second end portion side in the longitudinal direction of the display unit side body 3 in the opened state of the cellular telephone 1.

A sub-display (a second display) 32 for displaying a variety of information is disposed to be exposed on the rear case 3b of the display unit side body 3. The display 30 and sub-display 32 are composed of a liquid crystal display panel, a drive circuit that drives the liquid crystal display panel, and a light source unit such as a backlight that irradiates light from the back face side of the liquid crystal display panel. In the present embodiment, the display (the first display) 30 is larger than the sub-display (the second display) 32. It should be noted that the display 30 and sub-display 32 can be configured from organic EL displays.

The connecting portion 4 includes a biaxial hinge mechanism 20. The biaxial hinge mechanism 20 is a connecting mechanism that connects the display unit side body 3 and the operation unit side body 2 to be openable and closable about an opening-and-closing axis X as a first rotational axis at an arbitrary angle, while being connected to be pivotable about a pivot axis Y at an arbitrary angle. The biaxial hinge mechanism 20 is provided inside a hinge case 6. The hinge case 6 is disposed on a lower end side of the display unit side body 3. In an upper end portion of the operation unit side body 2, a notch portion 5 into which the hinge case 6 is inserted is formed. Both sides of the notch portion 5 are a pair of shoulder portions 7. The hinge case 6 is inserted into the notch portion 5 so as to be interposed between the pair of shoulder portions 7.

As described above, in the cellular telephone 1, the operation unit side body 2 and the display unit side body 3 are connected by the biaxial hinge mechanism 20 of the connecting portion 4 so as to be openable and closable, and pivotable. In such a configuration, the cellular telephone 1 can be transformed into various states by opening and closing the operation unit side body 2 and the display unit side body 3 about the opening and closing axis X, and pivoting about the pivot axis Y.

For example, the cellular telephone 1 in the closed state (the first closed state) in which the operation unit side body 2 and the display unit side body 3 overlap each other can be switched into the opened state (the first opened state) in which the operation unit side body 2 and the display unit side body 3 do not overlap each other by transforming the cellular telephone 1 to open about the opening and closing axis X such that respective end portions, which are on opposite sides of the opening and closing axis X, of the operation unit side body 2 and the display unit side body 3 are spaced apart from each other.

On the other hand, the cellular telephone 1 in the opened state (the first opened state) can be switched to the closed state (the first closed state) by transforming the cellular telephone 1 to close about the opening and closing axis X such that respective end portions, which are on opposite sides of the opening and closing axis X, of the operation unit side body 2 and the display unit side body 3 approach each other.

In addition, in the opened state (the first opened state), the display unit side body 3 can pivot about the pivot axis Y as shown in FIG. 2. Moreover, by further pivoting the display unit side body 3 about the pivot axis Y, the display unit side body 3 can be switched between the front side state and the back side state. More specifically, the opened state (the first opened state) in which the display 30 disposed on the front face 3A of the display unit side body 3 and the operation key group 11 disposed on the front face 2A of the operation unit side body 2 face to the same side can be switched into the opened state (the second opened state) in which the display 30 disposed on the front face 3A of the display unit side body 3 and the operation key group 11 disposed on the front face 2A of the operation unit side body 2 face opposite sides.

In addition, the cellular telephone 1 can be switched into the closed state (the second closed state) by transforming the display unit side body 3 to close about the opening and closing axis X. In other words, the cellular telephone 1 can be switched from the closed state in which the display 30 in the display unit side body 3 is disposed to oppose the operation key group 11 in the operation unit side body 2 (the first closed state) to the closed state in which the display 30 in the display unit side body 3 is exposed without opposing the operation unit side body 2 (the second closed state, a turned-closed state).

It should be noted that, although the cellular telephone 1 that is foldable by the connecting portion 4 is described in the present embodiment, the cellular telephone 1 is not limited thereto and may also be a slider type cellular telephone in which one of the bodies slides in one direction in a state where the operation unit side body 2 and the display unit side body 3 overlap each other, and a rotating-type (a revolver-type) cellular telephone in which one body is rotatable about an axis line that extends in an overlapping direction of the operation unit side body 2 and the display unit side body 3.

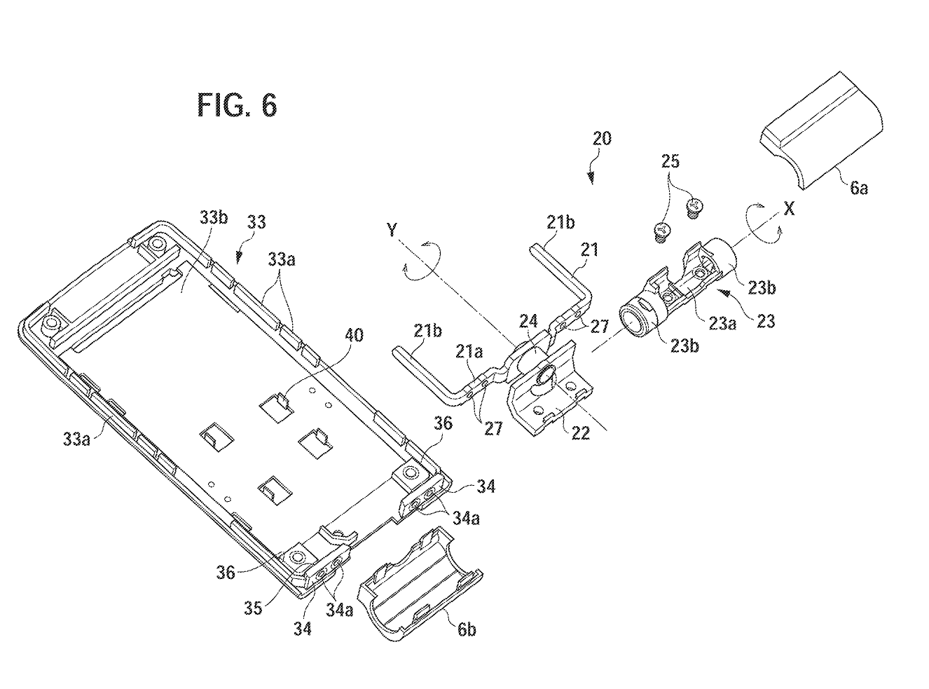

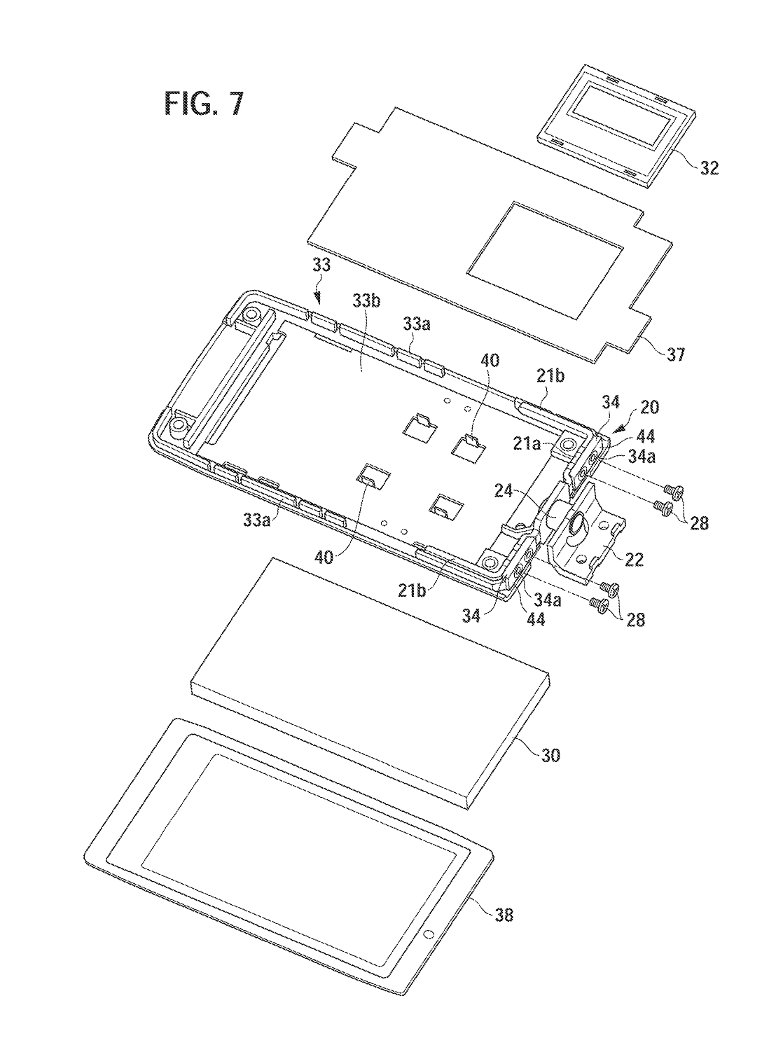

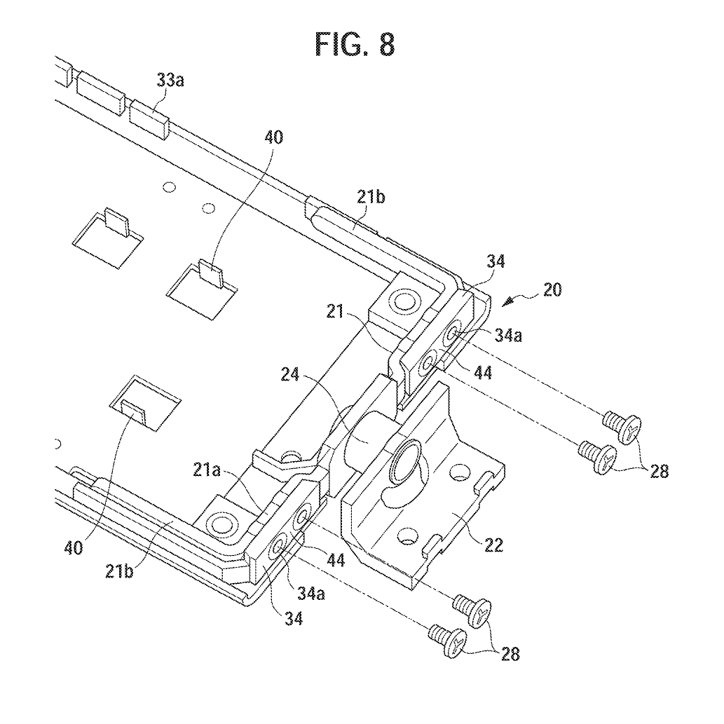

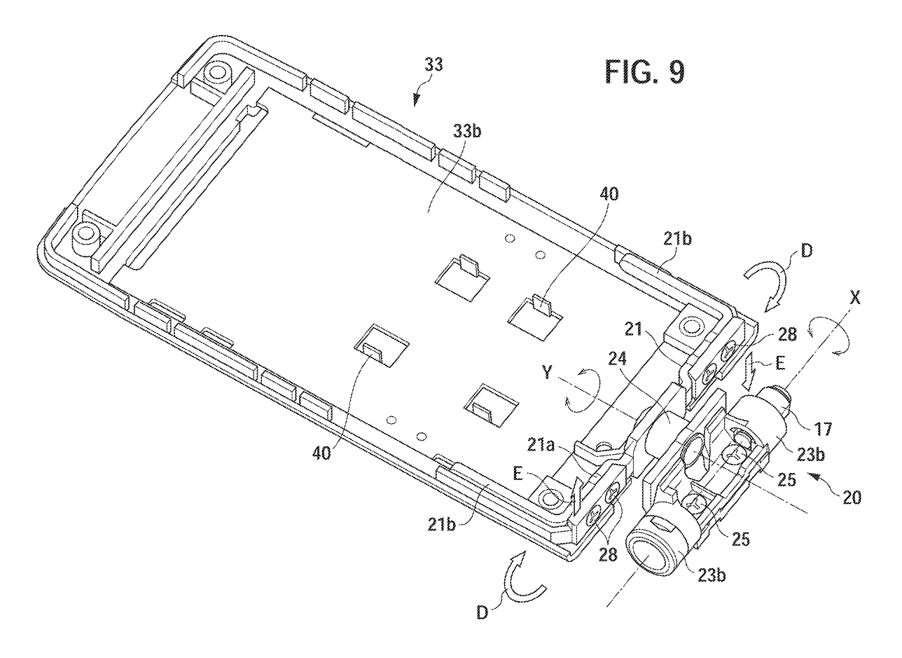

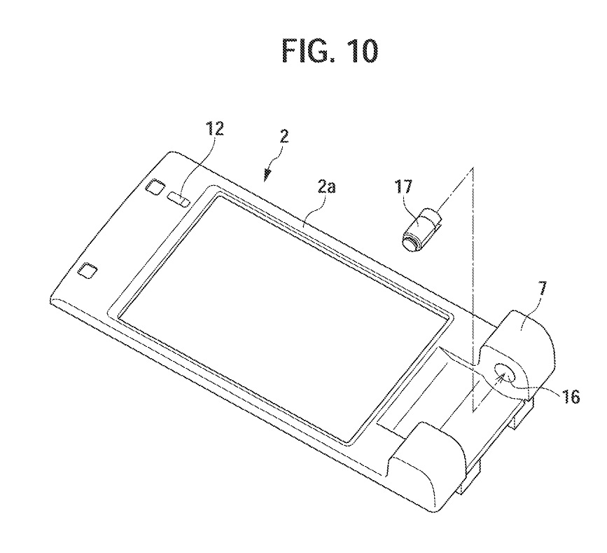

A structure of the biaxial hinge mechanism 20 is described with reference to FIGS. 6 to 10. FIG. 6 is an exploded perspective view of the biaxial hinge mechanism 20. FIG. 7 is a perspective view showing a fixing structure of the biaxial hinge mechanism 20. FIG. 8 is a partially enlarged perspective view of FIG. 7. FIG. 9 is a perspective view showing a fixed state of the biaxial hinge mechanism 20. FIG. 10 is a perspective view showing a support structure of the opening and closing axis X of the biaxial hinge mechanism 20.

As shown in FIG. 6, the biaxial hinge mechanism 20 includes a connection arm 21 as a fixed portion or other component, a connection bracket 22 having an L-shape for attaching the connection arm 21, and a connection tube 23 that is fixed to the connection bracket 22 with a plurality of screws 25. The connection arm 21 and the connection bracket 22 are connected with each other with a pivotal shaft 24 that is short bar shaped. The connection arm 21 is rotatable with respect to the connection bracket 22 via the pivotal shaft 24. In addition, the pivotal shaft 24 is rotatable with respect to the connection bracket 22 and extends in a direction of the pivot axis Y as a second rotational axis. The pivotal shaft 24 is thus a component of the rotation axis Y. In such a structure, the pivotal shaft 24 rotates with respect to the connection bracket 22, and thus the connection arm 21 can pivot about the pivot axis Y (the pivotal shaft 24). This allows relative rotation of the display unit side body 3 and the operation unit side body 2 in the opened state.

The connection tube 23 extends in a direction that is orthogonal to an axial direction of the pivotal shaft 24. Therefore, the connection tube 23 extends in an axial direction of the opening and closing axis X as the first rotational axis. The connection tube 23 includes a fixing piece 23a and tubular pieces 23b that are integrally formed on both sides of the fixing piece 23a. The connection bracket 22 is fixed by threads to the fixing piece 23a, and the connection bracket 22 is supported by fixing by threads. The connection tube 23 is connected to the operation unit side body 2 via the tubular pieces 23b.

As shown in FIG. 10, in an upper end portion of the front case 2a of the operation unit side body 2, the left and right shoulder portions 7, 7 are formed and a supporting hole 16 is formed on opposite faces of the left and right shoulder portions 7. The reference numeral 17 represents a hinge axis member (an axial module). The hinge axis member 17 has an outer shape such as a noncircular shape that would be obtained by parallel cutting a tubular shape. As shown in FIG. 9, a base portion of the hinge axis member 17 is inserted into the first tubular piece 23b of the connection tube 23. The connection tube 23 can relatively rotate about the hinge axis member 17. As shown in FIG. 10, a tip portion of the hinge axis member 17 is inserted into the front case 2a of the operation unit side body 2 and fixed to the front case 2a. As a result, the operation unit side body 2 thus rotates about a hinge axis, which is the first tubular piece 23b on a side to the hinge axis member 17. In other words, the operation unit side body 2 rotates about the connection tube 23, thereby opening and closing the bodies 2 and 3. It should be noted that, the second tubular piece 23b, into which the hinge axis member 17 is not inserted, is inserted into a hole portion (not shown) in the second shoulder portion 7 of the front case 2a and supports the front case 2a.

The connection bracket 22 and the connection tube 23 thus configured are disposed inside the hinge case 6. As shown in FIG. 6, the hinge case 6 is composed of a hinge front case 6a and a hinge rear case 6b, which are halves. An assembled body of the connection bracket 22 and the connection tube 23 is housed inside the hinge case 6 by inserting the connection bracket 22 and the connection tube 23 assembled with the screws 25 between the hinge front case 6a and the hinge rear case 6b, and then closing the hinge front case 6a and the hinge rear case 6b. In a state where the assembled body of the connection bracket 22 and the connection tube 23 is disposed inside the hinge case 6, the tip portion of the hinge axis member 17 and the second tubular piece 23b project outward in an axial direction (in a direction of the opening and closing axis X) from both end faces of the hinge case 6. Portions thus projecting connect the biaxial hinge mechanism 20 to the operation unit side body 2.

The connection arm 21 of the biaxial hinge mechanism 20 functions as the fixed portion or the other component and is channel-shaped as shown in FIGS. 6 to 9. The connection arm 21 is composed of a support arm portion 21a that extends in a direction orthogonal to the pivot axis Y as the second rotational axis, and holding arm portions 21b that are folded at a substantially right angle from both end portions of the support arm portion 21a. A central portion in a longitudinal direction of the support arm portion 21a is fixed to the pivotal shaft 24. A central portion in a longitudinal direction of the support arm portion 21a is fixed to the pivotal shaft 24. Since the connection arm 21 extends in a direction orthogonal to the pivot axis Y, the connection arm 21 rotates in the axial direction of the pivot axis Y.

As shown in FIGS. 6 to 8, the support arm portion 21a of the connection arm 21 includes threaded holes 27 at point-symmetrical positions along the pivotal shaft 24. In the present embodiment, two threaded holes 27 are formed at each of the symmetrical positions along the pivotal shaft 24. As shown in FIGS. 7 and 8, a fastening screw 28 is threaded into each of the threaded holes 27, thereby connecting the biaxial hinge mechanism 20 with the display unit side body 3. With such a connection by the threaded holes 27 positioned point-symmetrically, equal fixing power can be applied to right and left sides of the display unit side body 3.

The connection arm 21 is formed by processing to bend a metal plate. In other words, by pressing to bend a bar-shaped metal plate of a predetermined length, of which the thickness direction is the axial direction of the pivot axis Y, the support arm portion 21a and the holding arm portions 21b that extend from both end portions of the support arm portion 21a along the pivot axis Y are formed. In such processing, the connection arm 21 can be formed by performing processing to bend only once, thereby securing a predetermined strength thereof even if the connection arm 21 is small in thickness.

As shown in FIGS. 6 to 9, the display unit side body 3 has a support frame 33 as the first body piece (the front case 3a) as one of the body pieces composing the body. The display 30, as a component of the display unit side body 3, is fitted and fixed into a first face (an upper face) of the support frame 33. In addition, a sub-display 32 is attached to a second face (a lower face) of the support frame 33. In other words, the support frame 33 is disposed between the display 30 and the sub-display 32 and holds a back face side of the display 30 and the sub-display 32.

The entirety of the support frame 33 is formed of a metal member. The support frame 33 secures rigidity against a folding operation and a twisting operation in the display unit side body 3 and functions as a shield case against static electricity. In addition, the metal member constituting the support frame 33 is formed of a metal plate member so as to be foldable. By thus forming the support frame 33 of the metal plate member, a predetermined strength can be maintained even if the display unit side body 3 is made thin.

The front case 3a of the display unit side body 3 is formed by resin insert molding of the metal plate member. In the resin insert molding, the metal plate member has a structure almost entirely covered with a resin, thereby increasing design properties and anti-corrosion properties of an outer surface of the body. The support frame 33 has a frame face 33b of an elongated shape, and the display 30 is attached to a back face side of the frame face 33b. In this case, a plurality of teeth portions 33a are formed at a plurality of positions in both side end portions on a longitudinal side of the frame face 33b. The display unit side body 3 is assembled by first placing a substrate 37 and the sub-display 32 inside a region surrounded by the teeth portions 33a, and then engaging the rear case 3b with the front case 3a.

A standing tooth portion 40 is formed at a plurality of positions on a frame face 33b of the support frame 33. The standing tooth portion 40 is formed by cutting out and bending a predetermined portion of the frame face 33b. The standing tooth portion 40 is cut out and bent to correspond to the sub-display 32. The standing tooth portion 40 stands out from the frame face 33b toward a back face of the display 30, i.e. toward an upper face of the frame face 33b. The sub-display 32 is positioned by engaging with the standing tooth portions 40. More specifically, the back face and a periphery of the sub-display 32 are covered with a holder of a soft material such as rubber. The sub-display 32 is locked by the standing tooth portions 40 being inserted into slits 321 formed in the periphery on the back face thereof. The sub-display 32 can thus be fixed precisely at a designated position on a lower face of the support frame 33.

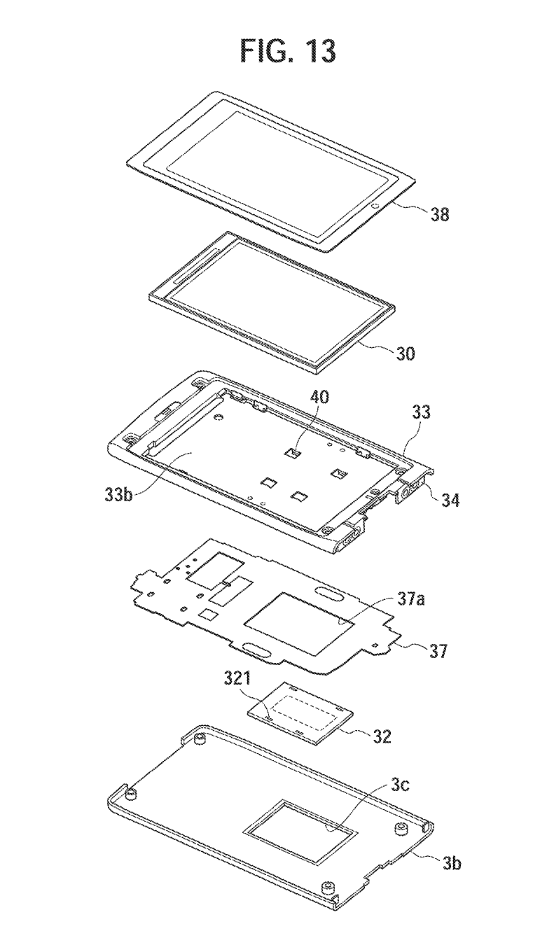

FIG. 13 is an exploded perspective view of components provided inside the display unit side body 3. The display unit side body 3 is provided with the front case 3a (see FIGS. 1 to 3), a cover panel 38, the display 30, the support frame 33, the substrate 37, the sub-display 32, and the rear case 3b. The cover panel 38, the display 30, the support frame 33 (the front case 3a), the substrate 37, and the sub-display 32 are housed between the front case 3a and the rear case 3b in this order from the front case 3a side.

The display 30 and the sub-display 32 are composed of a main body that displays information and the holder that holds the main body. The display 30 is disposed on an upper face side of the support frame 33. On the other hand, the substrate 37 and the sub-display 32 are disposed on a lower face side of the support frame 33. The cover panel 38 covers and protects the display 30.

Various electronic parts (not shown) are disposed on an installation surface of the substrate 37. The various electronic parts compose, in a predetermined combination, a circuit block such as a display control block that controls a display mode of the display 30 and the sub-display 32, a timing thereof, and the like. A window portion 37a is provided on the substrate 37 through which the sub-display 32 can be seen. A window portion 3c is provided on the rear case 3b through which the sub-display 32 can be seen. The sub-display 32 is fixed on the support frame 33 by engaging the slit 321 with the standing tooth portion 40 of the support frame 33 in a state where the substrate 37 contacts the lower face of the support frame 33.

The biaxial hinge mechanism 20 is connected to a first end portion on a lateral side of the support frame 33 (a lower end portion in FIGS. 6 to 8).

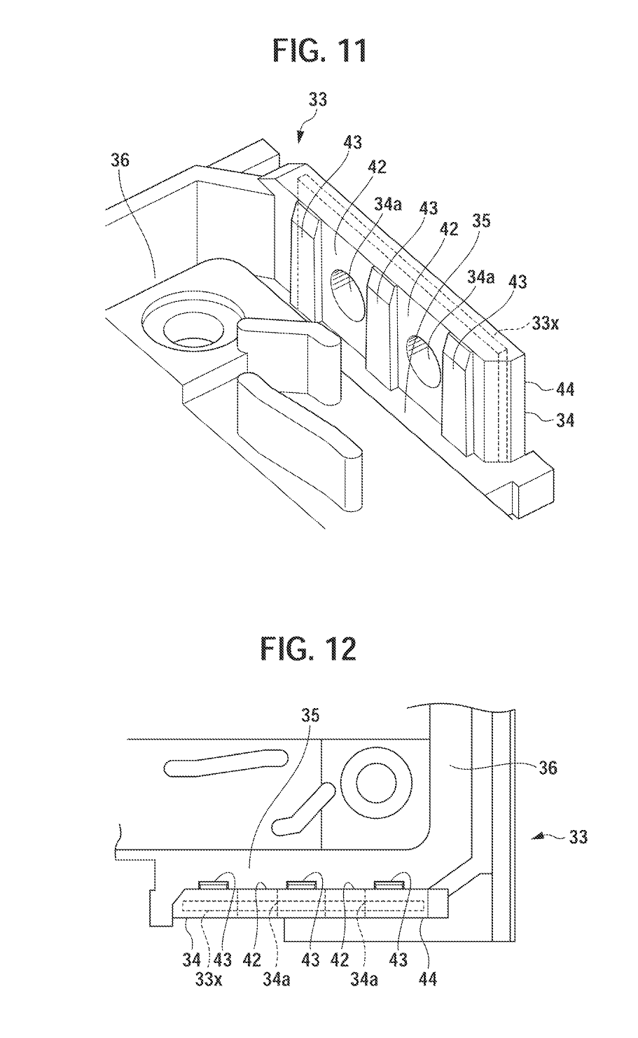

In the first end portion on the lateral side of the support frame 33, a connection wall portion 34 as the bent portion or the fastening portion is formed. The connection wall portion 34 is obtained by forming a resin mold layer on a portion of a resin insert molded metal plate member that is bent at a predetermined position. The connection wall portion 34 is formed to stand integrally from an end portion of the frame face 33b of the support frame 33. A bent portion 33x of a metal plate member in a state of being inserted into the connection wall portion 34 is shown by a dotted line in FIGS. 11 and 12. The connection wall portion 34 is provided at two symmetrical positions along a center line (a pivot axis Y) in the axial direction of the support frame 33. Each of the connection wall portions 34 extends in a direction orthogonal to the pivot axis Y as the second rotational axis. Each of the connection wall portions 34 has two threaded holes 34a, into which the fastening screw 28 is threaded, that are formed to penetrate the metal plate member inside the connection wall portion 34. The threaded hole 34a penetrates in a thickness direction of the connection wall portion 34. A penetrated end of the threaded hole 34a corresponds to a holder (not shown) for fixing the display 30. The holder has a threaded hole into which the fastening screw 28 is threaded. By threading the fastening screw 28 into the support arm portion 21a of the biaxial hinge mechanism 20 and the connection wall portion 34 of the support frame 33, the fastening screw 28 is threaded into the threaded hole of the holder. The display 30 can thus be fixed onto the support frame 33.

For each of the connection wall portions 34, two threaded holes 34a are formed at the symmetrical positions about the pivot axis Y. In addition, the threaded holes 34a in each of the connection wall portions 34 are formed to be slightly spaced apart from the pivot axis Y. The fastening screw 28 is threaded into the threaded holes 34a. In such a structure in which two threaded holes 34a in each of the connection wall portions 34 are formed to be slightly spaced apart from the pivot axis Y, the durability of the fastening screw 28 against a shearing force is increased. In other words, in a case where the display unit side body 3 rotates about the pivot axis Y, a shearing force E along a diametrical direction of a rotating circle D is applied to the fastening screw 28 as shown in FIG. 9; however, since a plurality (two) of the fastening screws 28 are provided and the fastening screws 28 are spaced apart from the pivot axis Y, the durability thereof against the shearing force E is increased.

A fitting groove 35 is formed on an inner side of the support frame 33 by press-processing of the metal plate member (see FIG. 6). The fitting groove 35 is provided along a longitudinal direction of the connection wall portion 34. The support arm portion 21a of the connection arm 21 in the biaxial hinge mechanism 20 is fitted into the fitting groove 35. In the present embodiment, sub fitting grooves 36 along a longitudinal direction of the support frame 33 are communicatively connected to both end portions of the fitting groove 35. The sub fitting grooves 36 extend from an end portion of the fitting groove 35, in a direction orthogonal to the fitting groove 35. The holding arm portions 21b of the connection arm 21 in the biaxial hinge mechanism 20 are fitted into the sub fitting grooves 36.

FIGS. 11 and 12 are, respectively, a partially enlarged perspective view and a plan view showing the connection wall portion 34 as the fastening portion. The connection wall portion 34 is formed by processing to bend the support frame 33 as the first body piece composed of a metal plate member. The support frame 33 is obtained by resin insert molding of the metal plate member. Therefore, the connection wall portion 34, which is integrally formed with the support frame 33, is also obtained by resin insert molding. Thus, the metal plate member is disposed inside the connection wall portion 34 and a resin covering the metal plate member is exposed to a surface of the connection wall portion 34.

The connection arm 21 of the biaxial hinge mechanism 20 acts as the other component to which the connection wall portion 34 is fixed by threads. As described above, in the connection arm 21, the support arm portion 21a is fitted into the fitting groove 35 of the support frame 33 while the holding arm portions 21b is fitted into the sub fitting grooves 36 of the support frame 33. In the above-mentioned fitted state, as shown in FIGS. 7 and 8, the fastening screw 28 is inserted and threaded into the threaded hole 34a of the connection wall portion 34, thereby fastening the connection wall portion 34 with the connection arm 21.

In such a fastening structure, the connection wall portion 34, which is a resin insert molding product, and the connection arm 21, which is composed of a metal plate member, are fixed by threads via a resin layer. A metal plate member (a metal member) of great strength is provided inside the connection wall portion 34 and the connection wall portion 34 is fixed by threads with respect to the metal plate member, thereby allowing threaded fixing of great fastening strength. In addition, since the metal plate member of the connection wall portion 34 and the connection arm 21 composed of a metal plate member are fastened via a resin layer that is softer than metal, loosening of a screw due to an external force such as vibration can be prevented more than in a case where only metal plate members are fixed by threads. Here, the fastening screw 28 can be formed of a conductive metal, thereby securing grounding (earth connection) by a metal member.

As shown in FIGS. 11 and 12, in each of the connection wall portions 34, a sloped surface 42 and a projecting surface 43 are formed. These surfaces 42 and 43 are formed on a side opposite to a screw stopping surface 44 (see FIGS. 7 and 8) that a head of the fastening screw 28 touches when the fastening screw 28 is inserted and fastened in the connection wall portion 34. In other words, these surfaces 42 and 43 are formed on a side of the connection wall portion 34 facing the support arm portion 21a of the connection arm 21.

The sloped surface 42 has a predetermined slope with respect to the screw stopping surface 44 into which the fastening screws 28 are inserted. Here, by making the screw stopping surface 44 parallel to a die removal direction, the sloped surface 42 is formed to incline toward a removal direction of a die used for resin insert molding of the connection wall portion 34 (the support frame 33). The sloped surface 42 is formed in a peripheral portion of each of the threaded holes 34a into which the fastening screw 28 is inserted. The projecting surface 43 is formed to be parallel to the screw stopping surface 44. In other words, the projecting surface 43 is formed to be parallel to the die removal direction. In addition, the projecting surface 43 projects more toward the side of the fitting groove 35 than the sloped surface 42, and is provided between the sloped surfaces 42 and on both sides of the sloped surface 42 in such a projecting state.

In a structure in which the sloped surface 42 is formed in the connection wall portion 34, since the sloped surface 42 provides a slope along with the die removal direction, the die can be easily removed, and therefore the connection wall portion 34 can be formed only with a pair of dies. In other words, in a case where the sloped surface 42 is not provided and only surfaces parallel to the die removal direction are provided in the connection wall portion 34, it is required to use a die including a core, an insert and the like for removal thereof; however, since the sloped surface 42 forms a slope along with the die removal direction, a die can be removed without using a core, an insert and the like. As a result, a structure of the die can be made simple while lowering a cost of the die.

In addition, by making the projecting surface 43 in the connection wall portion 34 parallel to the die removal direction, the projecting surface 43 can maintain parallelism with respect to the support arm portion 21a of the connection arm 21 and the projecting surface 43 can be in a close contact with the support arm portion 21a. As a result, the connection wall portion 34 is reliably made in close contact with the support arm portion 21a upon fastening with the fastening screw 28. The support frame 33 and the connection arm 21 can thus be reliably fastened with a great fastening force. Accordingly, the display unit side body 3 having the support frame 33 as a component can rotate smoothly without backlash between the support frame 33 and the connection arm 21. In addition, the projecting surface 43 can be continuously formed in a direction corresponding to the die removal direction. As a result, a contact area between the projecting surface 43 and the support arm portion 21a can be made greater and fastening therebetween can be stabilized.

In the present embodiment, the sloped surface 42 is formed to have a greater area than the projecting surface 43, thereby allowing for easy removal of the die with a smaller force.

Next, an assembly procedure of the cellular telephone 1 according to the present embodiment is described. First, the biaxial hinge mechanism 20 in a disassembled state shown in FIG. 6 is assembled. Then, the biaxial hinge mechanism 20 is fixed to the support frame 33 of the display unit side body 3. This fixing is realized by fitting the support arm portion 21a of the connection arm 21 into the fitting groove 35 of the support frame 33 while fitting the holding arm portions 21b into the sub fitting grooves 36 of the support frame 33. Thereafter, as shown in FIGS. 7 and 8, the fastening screws 28 are threaded from a side of the connection wall portion 34. The fastening screws 28 penetrate the threaded holes 34a of the connection wall portion 34 and the threaded holes 27 in the support arm portion 21a, and tips thereof are threaded into threaded holes (not shown) in the holder of the display 30. The fastening screws 28 thus realize fixing by threads in a direction orthogonal to a thickness direction of the display unit side body 3, thereby tightening together the display 30 and the biaxial hinge mechanism 20.

It should be noted that a screw (not shown) may be threaded into the holding arm portions 21b fitted into the sub fitting grooves 36, thereby fixing side faces of the display 30. The coupling force between the connection arm 21 and the support frame 33 can thus be increased.

On the other hand, as shown in FIG. 13, the sub-display 32 is attached to the support frame 33 by first bringing the substrate 37 into contact with a face of the support frame 33 opposite to an installation face of the display 30 (a lower face of the support frame 33), and then engaging the sub-display 32 with the standing tooth portions 40.

According to the cellular telephone 1 of the present embodiment that has the aforementioned configuration, the following effects are achieved, for example.

According to the present embodiment, the display 30, which is a component of the display unit side body 3, and the support arm portion 21a, which is the flat plate portion of the biaxial hinge mechanism 20, can be tightened together by way of fixing by threads with the fastening screws 28 in a direction orthogonal to a thickness direction of the display unit side body 3. With such a structure tightened together with the fastening screws 28 in a direction orthogonal to a thickness direction of the display unit side body 3, the cellular telephone 1 can be provided in which the display unit side body 3 can be reduced in thickness in a thickness direction and in size.

Since the connection arm 21 of the biaxial hinge mechanism 20 is formed of a metal plate member, the biaxial hinge mechanism 20 can be made thin while securing strength. This allows for a further reduction in the thickness of the display unit side body 3.

In addition, since the support frame 33 is formed by resin insert molding of a metal plate member, the connection wall portion 34 of the support frame 33 into which the fastening screws 28 are threaded is fastened with respect to the support arm portion 21a of the connection arm 21 via a resin molded layer formed by the resin insert molding. As a result, such fastening via a resin molded layer, which is made of a soft material, is more resistant to vibration and the like than a fastening between metal members and does not loosen the fastening screw 28. The support frame 33 (the display unit side body 3) and the connection arm 21 (the biaxial hinge mechanism 20) can thus be strongly connected.

According to the present embodiment, the support frame 33 that is formed by resin insert molding of the metal plate member is fixed by threads with the connection arm 21, which is a metal plate member, via a resin layer. As a result, threaded fixing with a great fastening force is possible and, in addition, since the metal plate members are fastened with each other via a soft resin layer, loosening of screws due to an external force such as vibration can be prevented more than in a case where only metal plate members are fixed by threads.

Furthermore, since the sloped surface 42 is formed in the connection wall portion 34, the die can be easily removed, and therefore the connection wall portion 34 can be formed only with a pair of dies. Moreover, by making the projecting surface 43 in the connection wall portion 34 parallel to the die removal direction, the projecting surface 43 can be made in a close contact with the support arm portion 21a and the support frame 33, and the connection arm 21 can be reliably fastened with a great fastening force.

The embodiment of the present invention has been described above; however, the present invention is not limited thereto and alterations thereto are possible as appropriate.

For example, in the abovementioned embodiment, the display unit side body 3 is the “first body” and the operation unit side body 2 is the “second body”; however, the present invention is not limited thereto and the operation unit side body 2 can be the “first body” and the display unit side body 3 can be the “second body”.

1. A portable electronic apparatus comprising: a first body that is substantially flat plate shaped;
a second body; and
a hinge portion that has a fixing portion that is fixed inside the first body and that connects the first body with the second body,
wherein the first body includes a metal plate member having a bent portion on an end side thereof that is bent in a thickness direction of the first body, and
wherein the bent portion of the metal plate member has a threaded hole and is tighten together with the fixing portion by way of a screw that is inserted into the threaded hole in a direction orthogonal to a thickness direction of the first body.

2. The portable electronic apparatus according to claim 1, wherein:
the hinge portion includes a first rotational axis that allows the first body to transition between an opened state and a closed state with respect to the second body, and a second rotational axis that allows the first body to rotate with respect to the second body by way of an axis orthogonal to the first rotational axis;
the hinge portion is fixed to the second body so as to be rotatable by way of the first rotational axis; and
the fixing portion is rotatable by way of the second rotational axis with respect to the hinge portion.

3. The portable electronic apparatus according to claim 1,
wherein the first body is configured to include a first body piece obtained by resin insert molding of the metal plate member, and
wherein the bent portion of the metal plate member is tightened together with the fixing portion by way of the screw via a resin layer formed by the resin insert molding.

4. The portable electronic apparatus according to claim 1,
wherein the first body includes a display, and
wherein the metal plate member is a member that holds a back face side of the display.

5. The portable electronic apparatus according to claim 4, wherein:
the first body includes a sub-display;
the metal plate member is provided with a standing tooth portion that is formed by cutting out and bending a portion of the metal plate member toward the back face side of the display; and
the sub-display is positioned by the standing tooth portion.

6. The portable electronic apparatus according to claim 3, wherein:
the resin layer formed on the bent portion includes a screw stopping surface on a first face thereof that a head of the screw abuts; and
a sloped surface having a predetermined slope with respect to the screw stopping surface and a projecting surface that has a face parallel to the screw stopping surface and projects more than the slope surface are formed on a face thereof that is opposite to the first face.

7. The portable electronic apparatus according to claim 6, wherein an area of the sloped surface is greater than that of the projecting surface.

8. The portable electronic apparatus according to claim 7,
wherein a surface direction of the screw stopping surface and the projecting surface is parallel to a die removal direction in molding of the first body piece, and
wherein the projecting surface is continuously formed in a direction corresponding to the die removal direction.

9. A portable electronic apparatus comprising a first body configured to include a first body piece obtained by resin insert molding of a metal member, wherein:
the metal member includes a fastening portion provided with a threaded hole;
the first body piece is configured by resin insert molding so that a resin layer is formed in the fastening portion of the metal member; and
the fastening portion of the first body piece is fixed by threads to another component with the resin layer interposed therebetween, by way of a screw inserted into the threaded hole.

10. The portable electronic apparatus according to claim 9, wherein:
the resin layer includes a screw stopping surface that a head of the screw abuts on a first face; and
a sloped surface having a predetermined slope with respect to the screw stopping surface and a projecting surface that has a face parallel to the screw stopping surface and projects more than the sloped surface are formed on a face thereof that is opposite to the first face.

11. The portable electronic apparatus according to claim 10, wherein an area of the sloped surface is greater than that of the projecting surface.

12. The portable electronic apparatus according to claim 10,
wherein a surface direction of the screw stopping surface and the projecting surface is parallel to a die removal direction in molding of the first body piece, and
wherein the projecting surface is continuously formed in a direction corresponding to the die removal direction.

13. The portable electronic apparatus according to claim 9, wherein the metal member comprises a metal plate member and the fastening portion is formed by processing to bend.

14. The portable electronic apparatus according to claim 9, further comprising a second body that is connected to the first body via a hinge member so as to be openable and closable,
wherein the other component is a component of the hinge member.

15. The portable electronic apparatus according to claim 14,
wherein the hinge member includes a second rotational axis with a direction vertical to the fastening portion set as an axis, and
wherein the fastening portion is provided at two positions interposing the second rotational axis.

16. The portable electronic apparatus according to claim 15, wherein:
the first body includes a display that is exposed on at least one face of the first body;
the hinge member includes a first rotational axis with a direction orthogonal to the second rotational axis set as an axis; and
the first body is foldable with respect to the second body, with the display facing inside, by way of the first rotational axis.

17. The portable electronic apparatus according to claim 14,
wherein the first body includes a first display and a second display so as to be exposed on faces thereof, and
wherein the metal plate member is disposed between the first display and the second display and respectively holds back faces of the first display and the second display,

18. The portable electronic apparatus according to claim 17, wherein:
the first display is greater in size than the second display;
the metal plate member comprises a standing tooth portion, which is formed by bending, on a face opposite to a face holding the first display; and
the second display is held by the standing tooth portion.
